(19) United States
(12) Patent Application Publication
(10) Pub. No.: US 2009/0301754 A1
(43) Pub. Date: Dec. 10, 2009

(54) CABLE MANAGEMENT SYSTEM

(76) Inventors: James Roger Morley-Smith, High Wycombe (GB); Quintin Morris, Seaford, NY (US); Nicole Daphne Tricoukes, Seaford, NY (US)

Correspondence Address: Nicole Daphne Tricoukes, 2620 Riverside Avenue, Seaford, NY, 11783, US

(21) Appl. No.: 12/134,370

(22) Filed: Jun. 6, 2008

(51) Int. Cl. H01B 7/00; H02G 3/04; B23P 19/00

(52) U.S. Cl. 174/113 R; 174/68.1; 29/745

(57) ABSTRACT

Methods and apparatus for connecting multiple conductors are described. One method includes providing a first conductor having a first outer jacket with a first mating feature. A second conductor having a second outer jacket with a second mating feature is positioned adjacent to the first mating feature of the first outer jacket. The first mating feature is mated to the second mating feature such that the first and the second outer jackets are removably coupled to each other.

### FIELD OF THE INVENTION

This description relates the organization and management of cables.

### BACKGROUND

Cable organizers such as cable clips or cable conduits are generally used to route cables and prevent cable tangling. These cable organizers are often integrated into permanent installations where cables will remain stationary except in cases of cable failure.

### SUMMARY

In one aspect of the invention, a cable includes a first conductor. A second conductor includes a coupling groove that is adapted to receive the first conductor such that the first and the second conductors are adjacent to each other when the first conductor is positioned in the coupling groove.

In one embodiment, one or both of the first and the second conductors is flexible. One or both of the first and the second conductors conducts at least one of an electrical signal, an optical signal and an acoustic signal. One or both of the first and the second conductors can include an insulator.

In one embodiment, a collar is positioned over the first and the second conductors. The collar facilitates the positioning of the first conductor into the coupling groove of the second conductor. In one embodiment, at least one of the first and the second conductors is cylindrical in shape.

In one embodiment, a third conductor is coupled to at least one of the first and the second conductors through a coupling groove.

In another aspect, the invention is embodied in a cable having a first conductor with a first outer jacket. The first outer jacket includes a first mating feature. A second conductor includes a second outer jacket. The second outer jacket includes a second mating feature that mates with the first mating feature. In one embodiment, the first and the second outer jackets are removably coupled to each other along a length of the cable.

In one embodiment, a collar at least partially surrounds the first and the second outer jackets. In one embodiment, the first mating feature is a tongue and the second mating feature is a groove. In another embodiment, the first and the second mating features include two portions of a zipper.

In one embodiment, at least one of the first and the second conductors is flexible. At least one of the first and the second conductors can be cylindrical in shape. The first and the second outer jackets can include an insulator.

In one aspect, the invention is embodied in a method for connecting multiple conductors. The method includes providing a first conductor having a first outer jacket with a first mating feature. A second conductor having a second outer jacket with a second mating feature is positioned adjacent to the first mating feature of the first outer jacket. The first mating feature is mated to the second mating feature such that the first and the second outer jackets are removably coupled to each other.

In one embodiment, the mating of the first and the second mating features includes positioning the first mating feature inside the second mating feature. In another embodiment, the mating of the first and the second mating features includes positioning the first mating feature alongside the second mating feature.

In one embodiment, the mating of the first and the second mating features includes moving a collar over the first and the second outer jackets. In one embodiment, the first mating feature includes a tongue and the second mating feature includes a groove. The mating includes positioning the tongue in the groove. In another embodiment, the first and the second mating features include two portions of a zipper.

### BRIEF DESCRIPTION OF THE DRAWINGS

This invention is described with particularity in the detailed description. The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates a cable management system according to one embodiment of the invention.

FIG. 2 illustrates a cable management system including coaxial cables according to one embodiment of the invention.

FIG. 3 illustrates a cable management system according to another embodiment of the invention.

FIG. 4 illustrates a method for decoupling and coupling multiple conductors according to one embodiment of the invention.

FIG. 5 illustrates a cable management system according to one embodiment of the invention.

### DETAILED DESCRIPTION

Ear buds are a type of headphones that are widely used with portable music players. The ear buds are coupled to wires that terminate at a standard plug. The plug mates with a connector in the music player. The wires from the ear buds are generally thin and tend to tangle when the ear buds are not in use.

Audio cables and video cables coupled to stereo and video equipment tends to be unorganized and unsightly unless professionally installed. Cables coupled between a personal computer and a video monitor, computer printer, computer speakers, modem, keyboard, and mouse also tend to be unorganized.

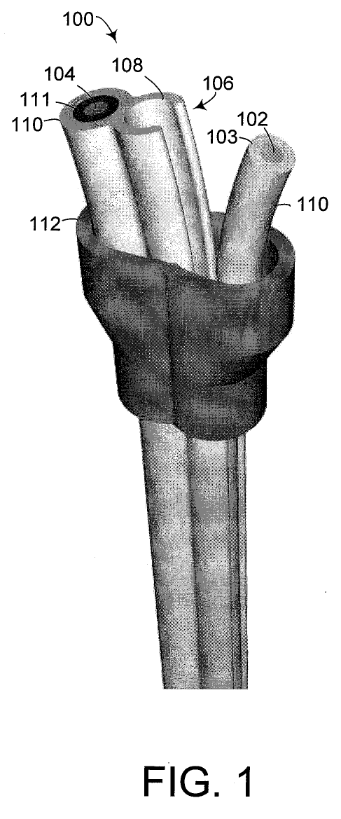

FIG. 1 illustrates a cable management system 100 according to one embodiment of the invention. The cable management system 100 includes a first conductor 102 having a first mating feature 103. A second conductor 104 includes a second mating feature 106 that is adapted to receive the first mating feature 103 of the first conductor 102. In this embodiment, the second mating feature 106 is a coupling groove 108 integrated with an outer jacket 110 of the second conductor 104. The second conductor 104 can also include a shield 111. The first 102 and the second conductors 104 are adjacent to each other when the first mating feature 103 of the first conductor 102 is positioned in the coupling groove 108.

In one embodiment, a collar 112 surrounds the first 102 and the second conductors 104. The collar 112 slides along the length of the first 102 and the second conductors 104. The collar 112 is adapted to urge the first mating feature 103 of the first conductor 102 into the coupling groove 108 of the second conductor 104. The collar 112 also secures the first 102 and the second conductors 104, thereby preventing an unintentional decoupling of the first 102 and the second conductors 104.

The first 102 and the second conductors 104 can be formed from conducting wire. An insulator or insulating jacket 110 can surround one or both of the conductors 102, 104. The insulating jacket 110 can be formed from a plastic material. The insulating jacket 110 prevents the first 102 and the second conductors 104 from shorting against each other. The insulating jacket 110 also provides protection for the first 102 and the second conductors 104 from the external environment. In one embodiment, the insulating jacket 110 provides strain relief for the first 102 and the second conductors 104. One or both of the first 102 and the second conductors 104 can include one or more electrical conducting wires, fiber optic cables, or acoustic waveguides. The conductors 102, 104 can conduct electrical signals, optical signals, or acoustic signals.

Although FIG. 1 illustrates an embodiment including two conductors 102, 104. In practice, any number of conductors can be used. In one embodiment, each conductor in the plurality of conductors includes a mating feature, such as a coupling groove, that is adapted to receive an adjacent conductor.

When the first conductor 102 and the second conductor 104 are separated, one method to removably join them according to one embodiment, is to position the mating feature 106 of the second conductor 104 adjacent to the mating feature 103 of the first conductor 102. Next, the second conductor 104 is mated with the first conductor 102 such that the first 102 and the second conductors 104 are removably coupled to each other. In one embodiment, a user can slide the conductors 102, 104 between her thumb and forefinger to facilitate the coupling. In one embodiment, to facilitate this coupling, the collar 112 surrounding the conductors 102, 104 is slid along a portion of the conductors 102, 104 in a lengthwise direction. The collar 112 urges the coupling of the conductors 102, 104.

In one embodiment, the second conductor 102 includes a mating feature that is positioned inside a mating feature of the first conductor 104. In another embodiment, a mating feature of the first conductor 102 is positioned alongside a mating feature of the second conductor 104. In one embodiment, the mating feature of a first conductor 102 is a tongue and the mating feature of the second conductor 104 is a groove. To removably couple the first 102 and the second conductors 104, the tongue is positioned in the groove. In another embodiment, the mating features are two portions of a zipper structure (not shown). In this embodiment, a collar (not shown) in the shape of a zipper pull couples the two potions of the zipper structure.

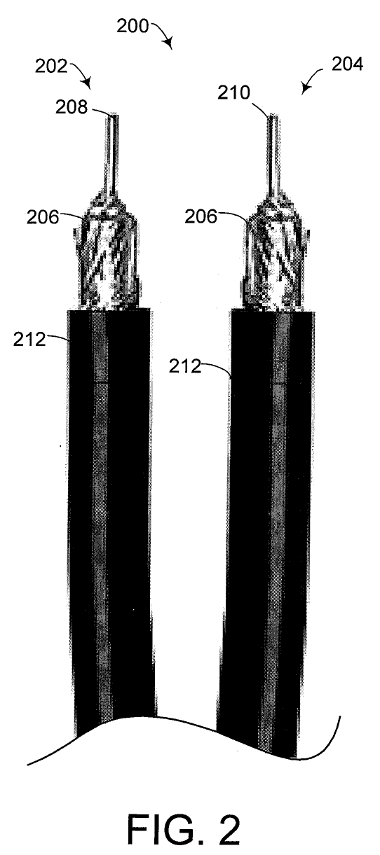

FIG. 2 illustrates a cable management system 200 including coaxial cables according to one embodiment of the invention. In this embodiment, each of the first 202 and the second conductors 204 includes a shield 206. The shield 206 minimizes environmental interference on the signal wires 208, 210 in the first 202 and the second conductors 204. For clarity, the coupling mechanism between the first 202 and the second conductors 204 is not shown. Each of the conductors 202, 204 also includes an insulating jacket 212. The insulating jacket 212 protects the conductors 202, 204 from the external environment and provides strain relief.

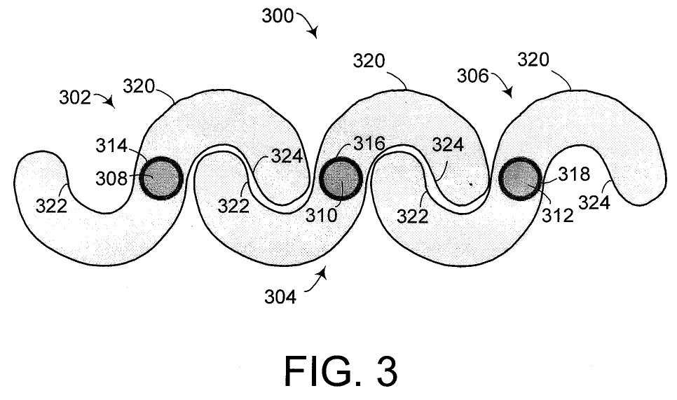

FIG. 3 illustrates a cable management system 300 according to another embodiment of the invention. The cable management system 300 includes a first conductor 302, a second conductor 304, and a third conductor 306. Any number of additional conductors can be coupled to the conductors 302, 304, 306. In one embodiment, the resulting cable resembles a ribbon-type cable.

Each conductor 302, 304, 306 includes a conducting medium 308, 310, 312. The conducting medium 308, 310, 312 can be an electrical wire, an optical waveguide, or an acoustic waveguide. A shield 314, 316, 318 surrounds each conducting medium 308, 310, 312.

A jacket 320 surrounds each shield 314, 316, 318. The jacket 320 is generally S-shaped and can provide insulation and protection for the conducting medium 308, 310, 312. The S-shaped jacket 320 includes two mating features 322, 324. The first mating feature 322 can be removably coupled to the second mating feature 324.

In one embodiment, the jacket forms at least one pliable hook that runs down at least one side of the conductor to allow it to be temporarily coupled to at least one more conductor with the same hook mechanism. The two hooks from the conductors can interlock through a process of pressing the hooks together. In one embodiment, a collar (not shown) surrounding the two conductors can facilitate the interlocking. The collar can be slid along the length of the conductor, forcing the two separate conductors to join.

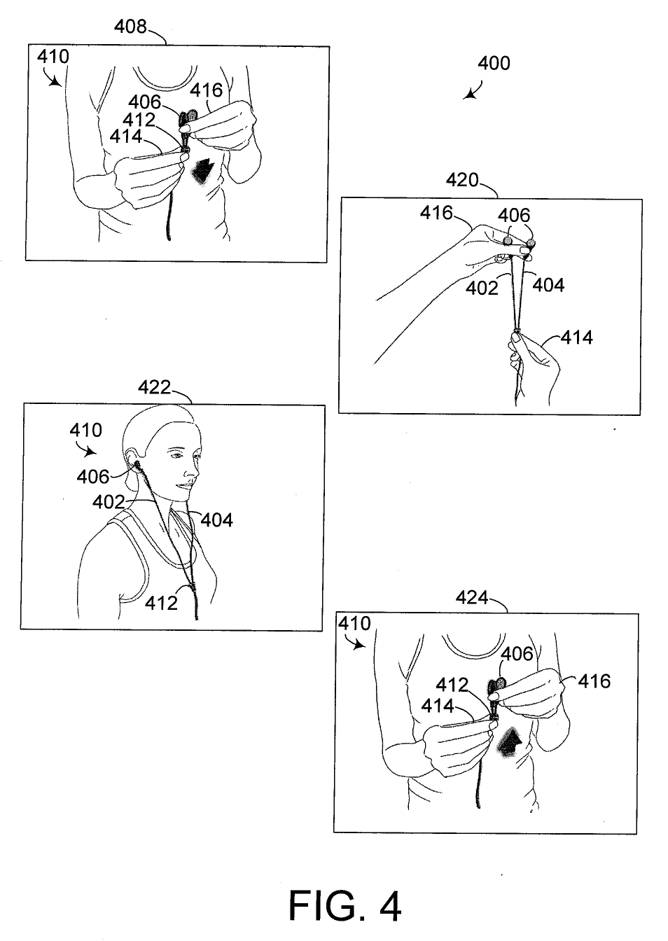

FIG. 4 illustrates a method 400 for decoupling and coupling multiple conductors 402, 404 according to one embodiment of the invention. In this embodiment, each of the two conductors 402, 404 include ear buds 406. In a first step 408, the conductors 402, 404 are initially coupled together and the user 410 grasps the collar 412 with one hand 414 and the ear buds 406 with the other hand 416. In a second step 420, the user 410 pulls the collar 412 away from the ear buds 406. In another embodiment (not shown), the user 410 can grasp each ear bud 406 with one hand 414, 416 and pull the ear buds 406 apart to separate the conductors 402, 404.

In a third step 422, the user 410 inserts the ear buds 406 into her ears and connects the other end of the conductors 402, 404 via a plug (not shown) to an audio source (not shown). When the user 410 is finished listening, the user 410 disconnects the plug from the audio source and removes the ear buds 406 from her ears. In a fourth step 424, the user 410 grasps the end of the conductors 402, 404 with one hand 416 and grasps the collar 412 with the other hand 414. The collar 412 is then moved toward the ear buds 406. To facilitate the movement of the collar 412, the user 410 can either grasp the ear buds 406 with one hand 416 or grasp the plug end of the conductors 402, 404 with the one hand 416 and move the collar 412 with the other hand 414. The first conductor 402 is mated to the second conductor 404 such that the first and the second conductors 402, 404 are removably coupled to each other.

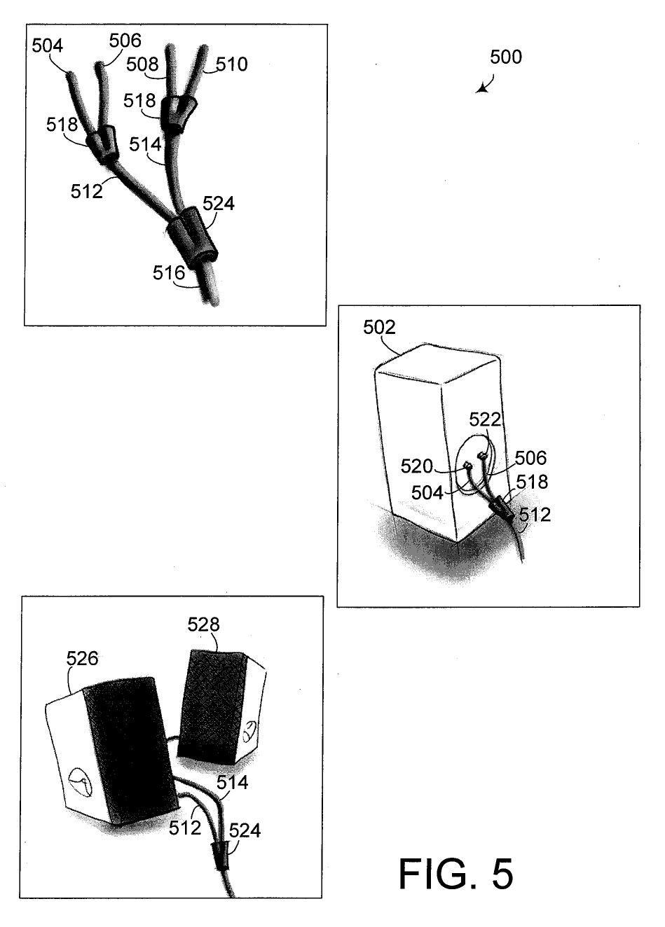

FIG. 5 illustrates a cable management system 500 according to one embodiment of the invention. The cable management system 500 can be used with loudspeakers 502. In this embodiment, four conductors 504, 506, 508, 510 emanate from an audio source (not shown). The four conductors 504, 506, 508, 510 derive from two pairs 512, 514 of two conductors each. The two pairs of conductors 512, 514 are removably coupled together to form a single cable 516. The single cable 516 is routed to output terminals (not shown) of the audio source.

In one embodiment, a collar 518 at least partially surrounds each of the pairs of conductors 512, 514. For example, the collar 518 on one pair of conductors 512 can be adjusted to allow each conductor 504, 506 to mate with a corresponding terminal 520, 522 on the loudspeaker 502.

Another collar 524 at least partially surrounds the two pairs of conductors 512, 514. The collar 524 can be adjusted to allow each pair of conductors 512, 514 to be routed to a respective loudspeaker 526, 528.

The nesting of conductors shown in FIG. 5 can be expanded to include as many nested conductors in as many configurations as required. In addition, the collars 518, 524 are not required to enable the coupling of the conductors.

In one embodiment, the invention reduces tangling of cables having multiple free ends. This invention can be used to temporarily join the loose ends of any cable, thereby preventing tangling and providing a dressed appearance.

The foregoing description is intended to be merely illustrative of the present invention and should not be construed as limiting the appended claims to any particular embodiment or group of embodiments. Thus, while the present invention has been described with reference to exemplary embodiments, it should also be appreciated that numerous modifications and alternative embodiments may be devised by those having ordinary skill in the art without departing from the broader and intended spirit and scope of the present invention as set forth in the claims that follow. In addition, the section headings included herein are intended to facilitate a review but are not intended to limit the scope of the present invention. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

What is claimed is:

1. A cable comprising:
a first conductor surrounded by a first insulator; and
a second conductor surrounded by a second insulator comprising a coupling groove adapted to receive the first insulator such that the coupling groove surrounds more than fifty percent of the first insulator when the first insulator is positioned in the coupling groove.

2. The cable of claim 1 wherein at least one of the first and the second conductors is flexible.

3. The cable of claim 1 wherein at least one of the first and the second conductors conducts at least one of an electrical signal, an optical signal and an acoustic signal.

4. The cable of claim 1 wherein at least one of the first and the second insulators comprises a plastic material.

5. The cable of claim 1 further comprising a collar that is positioned over the first and the second conductors, the collar facilitating the positioning of the first conductor into the coupling groove.

6. The cable of claim 1 wherein at least one of the first and the second conductors is cylindrical in shape.

7. The cable of claim 1 further comprising a third conductor surrounded by a third insulator comprising a third coupling groove adapted to receive the second insulator such that the third coupling groove surrounds more than fifty percent of the second insulator when the second insulator is positioned in the third coupling groove.

8. A cable comprising:
a first conductor having a first outer jacket comprising a first mating feature; and
a second conductor having a second outer jacket comprising a second mating feature that mates with the first mating feature such that when the first and the second outer jackets are removably coupled to each other along a length of the cable, the second mating feature surrounds more than fifty percent of the first mating feature.

9. The cable of claim 8 further comprising a collar that at least partially surrounds the first and the second outer jackets.

10. The cable of claim 8 wherein the first mating feature comprises a tongue and the second mating feature comprises a groove.

11. (canceled)

12. The cable of claim 8 wherein at least one of the first and the second conductors is flexible.

13. The cable of claim 8 wherein at least one of the first and the second conductors is cylindrical in shape.

14. The cable of claim 8 wherein at least one of the first and the second outer jackets comprises an insulator.

15. A method for connecting multiple conductors, the method comprising:
providing a first conductor having a first outer jacket comprising a first mating feature;
positioning a second conductor having a second outer jacket comprising a second mating feature adjacent to the first mating feature of the first outer jacket; and
mating the first and the second mating features such that the first and the second outer jackets are removably coupled to each other, the second mating feature surrounds more than fifty percent of the first mating feature.

16. The method of claim 15 wherein the mating the first and the second mating features comprises positioning the first mating feature inside the second mating feature.

17. The method of claim 15 wherein the mating of the first and the second mating features comprises positioning the first mating feature alongside the second mating feature.

18. The method of claim 15 wherein the mating of the first and the second mating features comprises moving a collar over the first and the second outer jackets.

19. The method of claim 15 wherein the first mating feature comprises a tongue and the second mating feature comprises a groove and the mating comprises positioning the tongue in the groove.

20. (canceled)

21. The cable of claim 1 wherein the first insulator further comprises a first coupling groove adapted to receive a third insulator surrounding a third conductor such that the first coupling groove surrounds more than fifty percent of the third insulator when the third insulator is positioned in the first coupling groove.

22. The cable of claim 8 wherein the first outer jacket further comprises a third mating feature that mates with a fourth mating feature of a third outer jacket surrounding a third conductor such that when the first and the third outer jackets are removably coupled to each other along a length of the cable, the third mating feature surrounds at least fifty percent of the fourth mating feature.
